(19) United States
(12) Patent Application Publication
(10) Pub. No.: US 2024/0313683 A1
(43) Pub. Date: Sep. 19, 2024

(54) METHOD FOR LIMITING A POWER OF AN ELECTRIC MOTOR

(71) Applicant: ZF Friedrichshafen AG, Friedrichshafen (DE)

(72) Inventors: Franz Prenner, Friedrichshafen (DE); Oussama Jabloun, Friedrichshafen (DE)

(73) Assignee: ZF Friedrichshafen AG, Friedrichshafen (DE)

(21) Appl. No.: 18/603,802

(22) Filed: Mar. 13, 2024

(30) Foreign Application Priority Data
Mar. 16, 2023 (DE) 10 2023 202 372.5

(51) Int. Cl. H02P 23/26

(52) U.S. Cl. CPC H02P 23/26

(57) ABSTRACT

Disclosed is a method (1) for limiting (3) a power of an electric motor (2), the method (1) including an estimation process (P1) in which a loading of the electric motor (2) is estimated.

### RELATED APPLICATIONS

This application claims the benefit of and right of priority under 35 U.S.C. § 119 to German Patent Application no. 10 2023 202 372.5, filed on 16 Mar. 2023, the contents of which are incorporated herein by reference in its entirety.

### TECHNICAL FIELD

The invention relates to a method for limiting a power of an electric motor, as well as to a system, a vehicle, a computer program, and a computer-readable medium, as variously disclosed herein.

### BACKGROUND

Nowadays more and more motor vehicles are powered by electric motors. With such electric motors typically there occur cases when the electric motors become very hot, i.e., for example reach certain temperature values and/or during operation take up certain amounts of energy resulting in a limitation of the power of such electric motors and to a power reduction. In such cases one speaks of a loading of the electric motor, also referred to as a thermal loading. In this connection a utilization factor C is also mentioned, which describes the thermal and magnetic loading of the active material of the electric motor. When an electric motor is loaded beyond a certain limit, particularly thermally loaded, then typically a characteristic power reduction takes place which, for example, is perceived by a driver of the motor vehicle if he calls for a high motor torque by actuating the accelerator pedal. In cases where there is high thermal loading, the desired motor torque is then no longer delivered but instead a power restriction occurs.

On the other hand, motor vehicles of the same type are often sold with different motors fitted in them. In cases like this, it also happens that in such vehicles electric motors of the same structure are used, but which are then electronically downward-regulated, i.e., limited in their power if the vehicle is sold with a lower power. In such cases, a simple power-throttling of the electric motor cannot reproduce realistically the behavior of a motor with lower power. Such “artificial” power limitation can be perceived by drivers as unrealistic and unpleasant.

### SUMMARY

The purpose of the present invention is to overcome the disadvantages of the prior art, or at least to reduce them.

This objective is achieved by a method for limiting a power of an electric motor, which method comprises an estimation process in which a loading of the electric motor is estimated. The inventors have found that the fact that with a simple power-throttling of an electric motor, for example by limiting the current supplied by an inverter, the behavior of the electric motor does not correspond to the behavior of an electric motor which in fact actually has the maximum power to which, in the context of power limitation, the power is downward-regulated. The invention found that this problem can be mitigated by estimating the loading of the electric motor in an estimation process, because in that way the loading which would occur in an electric motor with lower power is taken into account.

In typical embodiments, the method comprises a limiting process in which the power limitation is adjusted on the basis of the loading estimated in the estimation process and an actual operating parameter of the electric motor, wherein the actual operating parameter is preferably an actual rotation speed or an actual motor torque. In typical embodiments, such a limiting process comprises two part-processes, namely a rotation-speed-limiting part-process and a thermal-limiting part-process. In the rotation-speed-limiting part-process, as a function of the rotation speed of the electric motor a maximum possible motor torque is set. In the thermal-limiting part-process, typically a maximum permissible motor torque is determined as a function of the loading estimated in the estimation process. In typical embodiments the limiting process comprises only the thermal-limiting part-process but not the rotation-speed-limiting part-process.

In typical embodiments, the loading is a fictive thermal loading. The inventors found that the loading of the electric motor estimated in the estimation process can be pictured as a fictive thermal loading in a particularly simple way. In this context, a fictive thermal loading is understood to mean a value or a group of values which are determined on the basis of temperature values and/or power values and/or energy values. That loading is in this case called “fictive” because it does not correspond to the actual loading of the electric motor, but rather, it denotes an estimated loading which can then be used in the context of the limiting process to produce a realistic power reduction of the electric motor.

In typical embodiments, the fictive thermal loading is calculated on the basis of a power loss of the electric motor and a cooling capacity of the electric motor. Such a calculation of the loading is advantageous, because the power loss and the cooling capacity during the operation of the electric motor can be determined relatively simply. The power loss and the cooling capacity of the electric motor are typically sent to the estimation process as input variables, typically continuously. Thus, on the basis of those two variables, the estimation process can estimate the loading of the electric motor, in particular the fictive thermal loading. Alternatively, or in combination therewith, it is also possible for an outside temperature to be sent to the estimation process as an input variable. Other input variables are also conceivable, for example, a temperature in the motor space of the vehicle or a temperature in the inside space of the vehicle.

In advantageous embodiments, the estimation process comprises a multiplicity of part-processes, namely a first subtraction process in which the power loss is calculated by subtracting a mechanical motor power from an electric power supplied to the electric motor, a second subtraction process in which a thermal performance is determined by subtracting the cooling capacity from the power loss, an integration process in which the thermal performance is integrated over an operating time of the electric motor so that a fictive thermal energy value is obtained continuously, such that the fictive thermal energy value is typically the fictive thermal loading, a comparison process in which the fictive thermal energy value is compared with a downward-regulation function, wherein the downward-regulation function describes a fictive correction factor as a function of the fictive energy value, and an output process in which the fictive thermal correction factor is emitted by the estimation process and is sent to the limiting process as an input parameter.

In advantageous embodiments, the downward-regulation function is designed such that the fictive thermal correction factor has the value “1” so long as the fictive thermal energy value is between “0” and an energy limit value, and the fictive thermal correction factor decreases linearly from the value “1” to the value “0” so long as the fictive thermal energy value has a value between the energy limit value and a maximum energy value, and the fictive thermal correction factor has the value “0” when the fictive thermal energy value is larger than the maximum energy value. Such a downward-regulation function has the advantage that it can be implemented easily, because it can be implemented by determining the energy limit value and the maximum energy value.

In advantageous embodiments, the energy limit value is calculated as a function of the maximum energy value, as follows:

Energy limit value=α×Maximum energy value

in which α is a downward-regulation constant, such that the downward-regulation constant preferably describes a percentage of a maximum power of the electric motor, the downward-regulation constant advantageously having a value between 20% and 80%, preferably between 30% and 70%, advantageously between 40% and 60%, and best of all a value of about 50%.

In this patent application, at least in many example embodiments, the term “about” should be understood to mean that it expresses a tolerance of ±20%, advantageously ±10%, and preferably ±5%.

The objective is also achieved by a system that comprises means for at least partially carrying out a method according to at least one of the aforesaid embodiments.

Typically, such a system comprises an estimation component, which is suitable for estimating the loading of the electric motor, in particular the fictive thermal loading of the electric motor.

In advantageous embodiments, the system is suitable for carrying out, at least partially, and/or coordinating and/or controlling a method for limiting a power of an electric motor according to at least one of the aforesaid embodiments. For that purpose, the system advantageously comprises suitable components, for example, the already mentioned estimation component and/or a limiting component and/or a power loss determining component and/or a cooling capacity determining component and/or a first subtraction component and/or a mechanical motor power determining component and/or an electric power determining component and/or a second subtraction component and/or an integration component and/or a comparison component and/or a downward-regulation component and/or an output component and/or a temperature determining component and/or a control component suitable for controlling the method.

To good advantage, at least some of the aforesaid components in the system are implemented by means of computer program codes. In advantageous embodiments, the system, in particular some of the components, is at least partially part of a vehicle control system and/or a Cloud. In typical embodiments, the system comprises a digital control unit and/or a display and/or data input means and/or data output means.

In an embodiment of the invention, a vehicle is suitable for carrying out a method according to at least one of the aforesaid embodiments, and/or comprises a system according to at least one of the aforesaid embodiments. For that purpose, the vehicle typically contains means for carrying out a method according to at least one of the aforesaid embodiments.

In an embodiment of the invention, a computer program contains commands which, when the computer program is run on a computer, enable it to carry out one of the methods. The computer program can also be referred to as a computer program product.

In an embodiment of the invention, a computer-readable medium contains computer program codes for carrying out one of the methods. The term “computer-readable medium” is understood to mean, in particular but not exclusively, hard disks and/or servers and/or memory sticks and/or flash memories and/or DVDs and/or Bluerays and/or CDs. In addition, the term “computer-readable medium” is understood to include a data stream such as that produced, for example, when a computer program and/or a computer program product is downloaded from the internet.

### BRIEF DESCRIPTION OF THE FIGURES

Below, the invention is explained briefly with reference to figures, which show:

FIG. 1: A schematic representation of a first embodiment of a method according to the invention,

FIG. 2: A schematic representation of a second embodiment of a method according to the invention,

FIG. 3: A schematic representation of an estimation process according to the invention,

FIG. 4: A schematic representation of a downward-regulation function according to the invention, and

FIG. 5: A schematic representation of a vehicle according to the invention.

### DETAILED DESCRIPTION

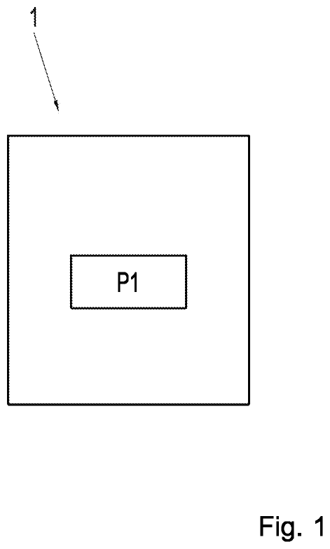

FIG. 1 shows a schematic representation of a first embodiment of a method according to the invention, in the form of a block diagram. In particular, FIG. 1 shows schematically a method 1 for limiting a power of an electric motor (not shown in FIG. 1). The method 1 comprises an estimation process P1 in which a loading of the electric motor is estimated. In the method 1 the estimation process P1 preferably takes place continuously, for example, in the form of an endless loop, which is carried out continuously during the operation of a vehicle in which, typically, the electric motor is installed.

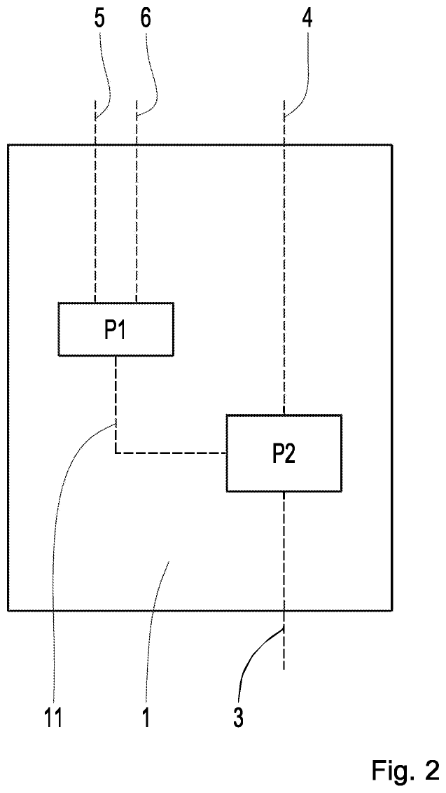

FIG. 2 shows a schematic representation of a second embodiment of a method according to the invention, again in the form of a block diagram. In particular, FIG. 2 shows a method 1 which comprises an estimation process P1 as already described in the case of FIG. 1. In principle, everything said with reference to FIG. 1 also applies to the example embodiment shown in FIG. 2. In addition to the example embodiment shown in FIG. 1, the method 1 in FIG. 2 also comprises a limitation process P2. Furthermore, in FIG. 2 data streams 3, 4, 5, 6, 11 are shown, which are represented by broken lines. In particular, in the method illustrated in FIG. 2 a power loss 5 and a cooling capacity 6 of the electric motor whose power is to be limited (again, the electric motor itself is not shown in FIG. 2) are sent to the estimation process P1 as input variables. On the basis of the power loss 5 and cooling capacity 6, in the estimation process P1 a fictive thermal correction factor 11 is calculated. This fictive thermal correction factor 11 is sent to the limitation process P2. In addition, a current, actual operating parameter 4 of the electric motor is sent to the limitation process P2. In typical embodiments the current operating parameter 4 is an actual rotation speed of the electric motor. On the basis of the fictive thermal correction factor 11 and the current operating parameter 4, the limitation process P2 calculates a limitation 3. In typical embodiments, the limitation 3 comprises segmentation limits and/or values which relate to a limitation of the power of the electric motor, or at least a limitation value.

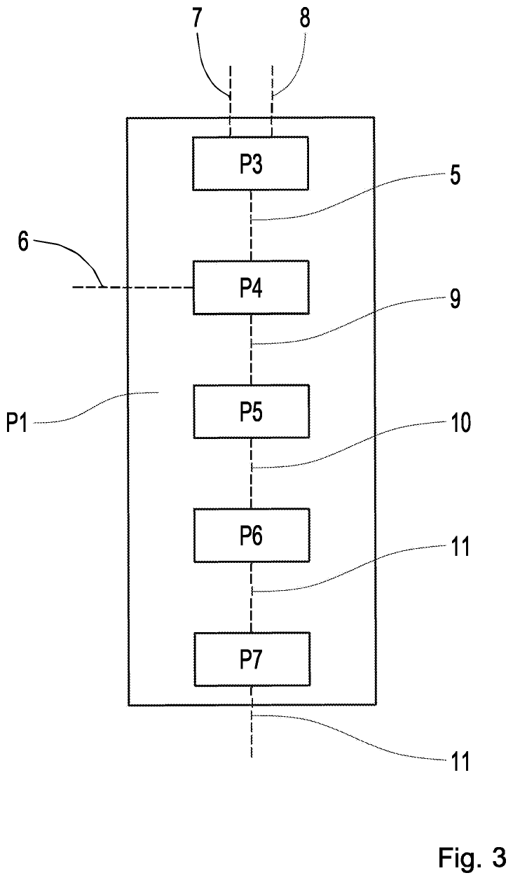

FIG. 3 shows a schematic representation of an estimation process P1 according to the invention which, for example, can be used in the methods shown in FIGS. 1 and 2. The estimation process P1 comprises a number of part-processes, namely a first subtraction process P3, a second subtraction process P4, an integration process P5, a comparison process P6 and an output process P7. A mechanical motor power 7 and an electrical power 8 are transmitted to the first subtraction process P3. The mechanical motor power is an actual mechanical motor power of an electric motor (not shown in FIG. 3), the power of which is to be limited. The electrical power 8 is the electrical power supplied to this electric motor. In the first subtraction process P3 the mechanical motor power 7 is subtracted from the electrical power 8 so that the power loss 5 is emitted. This power loss 5 is sent to the second subtraction process P4. In addition, a cooling capacity 6 that corresponds to the actual cooling capacity of the electric motor is sent to the second subtraction process P4. In the second subtraction process P4 the cooling capacity 6 is subtracted from the power loss 5, so that the thermal capacity 9 is obtained. This thermal capacity 9 is sent to the integration process P5 in which it is integrated over the operating time of the electric motor, in particular continuously during an entire operating period of the electric motor. Thus, on the output side of the integration process P5 a fictive thermal energy value 10 is emitted. This fictive thermal energy value 10 is sent to the comparison process P6. In the comparison process P6 the fictive thermal energy value 10 is compared with a downward-regulation function (not shown in FIG. 3), wherein the downward-regulation function describes a fictive thermal correction factor 11 as a function of the fictive thermal energy value 10. Thus, on its output side the comparison process P6 emits the fictive thermal correction factor 11. The fictive correction factor 11 is then sent on to the output process P7, which passes the fictive thermal correction factor 11 on to a limitation process of the method (not shown in FIG. 3). The output process P7 is optional, i.e., it does not have to be present. Rather, it is also possible for the comparison process P6 to pass the fictive thermal correction factor 11 directly on to a limitation process.

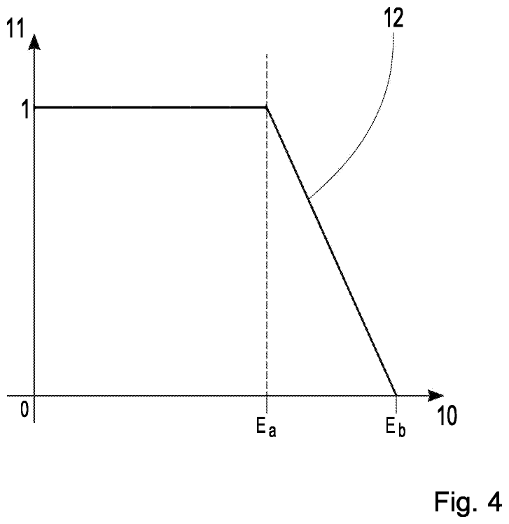

FIG. 4 shows a schematic representation of a downward-regulation function 12 according to the invention. On the x-axis of the function diagram shown, the fictive energy value 10 is plotted. On the y-axis the fictive thermal correction factor 11 is plotted. In other words, in the diagram of FIG. 4 the fictive correction factor 11 is shown as a function of the fictive energy value 10. On the x-axis two energy values are marked explicitly, namely, an energy limit value Eₐ and a maximum energy value E_{b}. For a fictive thermal energy value 10 between “0” and the energy limit value Eₐ the fictive correction factor 11 has the value “1”. In a range where the fictive thermal energy value 10 is higher than the energy limit value Eₐ but lower than the maximum energy value E_{b}, the fictive thermal correction factor 11 decreases linearly from the value “1” to the value “0”. Should the fictive thermal energy value 10 become higher than the maximum energy value E_{b}, the fictive thermal correction factor 11 would have the value “0”. With the help of this downward-regulation function 12 it is made possible, from an operating point in time when a particular energy limit value Eₐ which describes a certain uptake of thermal energy by the electric motor, to reduce the power of an electric motor progressively and linearly. In this way, with such an electric motor a power limitation caused by loading can be simulated even though the electric motor is not yet actually loaded in that manner. Thus, in other words a fictive thermal correction factor 11 is calculated and so a fictive loading is estimated, which is used to limit the power of the electric motor.

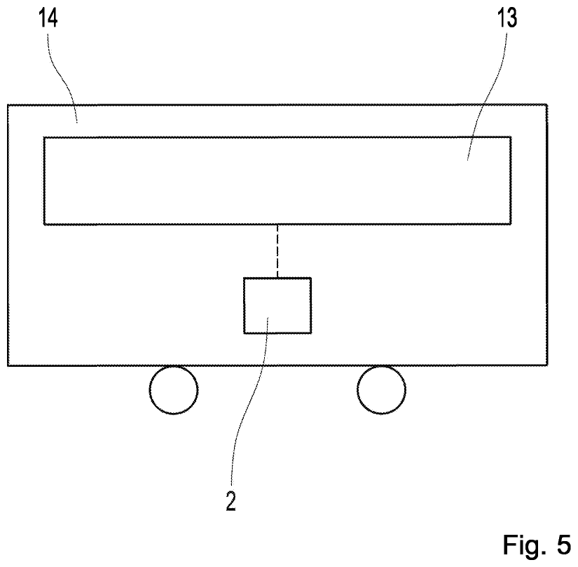

FIG. 5 now shows a schematic diagram of a vehicle 14 according to the invention. The vehicle 14 comprises a system 13 which is suitable for carrying out a method according to the invention. For that purpose, the system 13 comprises means for at least partially carrying out the method. For the sake of greater simplicity, the means, for example corresponding components, which can be implemented at least partially with the help of computer program codes, are not represented explicitly in the system 13. The system 13 is connected to an electric motor 2 and is thus capable of limiting a power of the electric motor 2.

The invention is not limited to the example embodiments described. Its protective scope is defined by the claims.

In principle, all the methods described in the description section or in the claims can be carried out by devices which contain means for carrying out the respective process steps of the method.

### INDEXES

1 Method
2 Electric motor
3 Limitation
4 Current operating parameter
5 Power loss
6 Cooling capacity
7 Mechanical motor power
8 Electrical power
9 Thermal power
10 Fictive thermal energy value
11 Fictive thermal correction factor
12 Downward-regulation function
13 System
14 Vehicle
Eₐ Energy limit value
E_{b} Maximum energy value
P1 Estimation process
P2 Limitation process
P3 First subtraction process
P4 Second subtraction process
P5 Integration process
P6 Comparison process
P7 Output process

1-11. (canceled)

12. A method (1) for limiting (3) a power of an electric motor (2), the method comprising:
determining, by a processor, an estimated loading of the electric motor (2).

13. The method (1) according to claim 12, comprising:
determining, by the processor, a limitation (3) of the power based on the estimated loading and based on a current operating parameter (4) of the electric motor (2), wherein the current operating parameter is selected from an actual rotation speed and an actual motor torque of the electric motor.

14. The method (1) according to claim 13, wherein the estimated loading is a fictive thermal loading.

15. The method (1) according to claim 14, wherein the fictive thermal loading is calculated on the basis of a power loss (5) of the electric motor (2) and on the basis of a cooling capacity (6) of the electric motor (2).

16. The method according to claim 15, wherein determining the estimated loading comprises:
calculating a power loss (5) in a first subtraction process (P3) by subtracting a mechanical motor power (7) from an electrical power (8) supplied to the electric motor (2);
determining a thermal power in a second subtraction process (P4) by subtracting a cooling capacity (6) from the power loss (5);
integrating the thermal power (9) over an operating period of the electric motor (2) in an integration process (P5) so that the fictive thermal energy value (10) is obtained continually, and wherein the fictive energy value (10) represents the fictive thermal loading;
comparing the fictive energy value (10) with a downward-regulation function (12) in a comparison process (P6), wherein the downward-regulation function (12) relates a fictive thermal correction factor (11) as a function of the fictive energy value (10);
emitting, in an output process (P7), the fictive thermal correction factor (11) determined by the estimation process (P1); and
providing the fictive thermal correction factor (11) as in put variable to the limitation process (P2).

17. The method (1) according to claim 16, wherein the downward-regulation function (12) is formed in such manner that:
the fictive thermal correction factor (11) has the value “1” so long as the fictive energy value (10) has a value between “0” and an energy limit value (Eₐ);
the fictive thermal correction factor (11) decreases linearly from the value “1” to the value “0” so long as the fictive energy value (10) has a value between the energy limit value (Eₐ) and a maximum energy value (E_{b}); and
the fictive correction factor (11) has the value “0” when the fictive energy value (10) is larger than the maximum energy value (E_{b}).

18. The method (1) according to claim 17, comprising:
calculating the energy limit value (Eₐ) as a function of the maximum energy value (E_{b}) as follows:
Energy limit value=α×Maximum energy value
in which α is a downward-regulation constant that relates a percentage of a maximum power of the electric motor (2); and
wherein the downward-regulation constant advantageously has a value from 20% to 80%.

19. The method of claim 18, wherein the downward-regulation constant is from 30% to 70%.

20. The method of claim 18, wherein the downward-regulation constant is from 40% to 60%.

21. The method of claim 18, wherein the downward-regulation constant is from 45-55%.

22. A system (13), comprising means for at least partially carrying out the method according to claim 15.

23. A vehicle (14) comprising a system configured for carrying out the method (1) according to claim 15.

24. A computer-readable medium containing executable code that, when executed by a processor, carries out the method according to claim 15.

25. A method (1) for estimating a loading of an electric motor (2) in a vehicle, the method comprising:
calculating a power loss (5) by subtracting a motor (2) in a vehicle, the method comprising:
calculating a power loss (5) by subtracting a mechanical motor power (7) from an electrical power (8) supplied to the electric motor (2);
determining a thermal power by subtracting a cooling capacity (6) from the power loss (5);
integrating the thermal power (9) over an operating period of the electric motor (2) so that a fictive thermal energy value (10) is obtained continually, and wherein the fictive energy value (10) represents the fictive thermal loading;
comparing the fictive energy value (10) with downward-regulation function (12), wherein the downward-regulation function (12) relates a fictive thermal correction factor (11) as a function of the fictive energy value (10).

26. The method of claim 25, comprising calculating the fictive thermal loading based on a power loss (5) of the electric motor (2) and based on a cooling capacity (6) of the electric motor (2).
